(19) United States
(12) Patent Application Publication
(10) Pub. No.: US 2005/0206664 A1
(43) Pub. Date: Sep. 22, 2005

(54) Car entertainment system and associated printer

(75) Inventor: Kia Silverbrook, Balmain, NSW (AU)

Correspondence Address: SILVERBROOK RESEARCH PTY LTD, 393 DARLING STREET, BALMAIN, 2041, AU

(73) Assignee: Silverbrook Research Pty Ltd, Balmain, NSW (AU)

(21) Appl. No.: 10/503,927

(22) PCT Filed: Feb. 12, 2003
(86) PCT No.: PCT/AU03/00158

§ 371 Date: Aug. 9, 2004

(30) Foreign Application Priority Data
Feb. 13, 2002 (AU) PS 0473

(51) Int. Cl. B41J 3/00

(52) U.S. Cl. 347/2

(57) ABSTRACT

An onboard information retrieval system includes a user terminal operable by a user to access a source of the information. A communications unit is arranged in the conveyance to download data from the source of the information. A processor, in communication with said user terminal, processes the data to provide formatted data suitable for printing. An onboard printing unit is associated with the user terminal for printing the formatted data to provide the information.

### CO-PENDING APPLICATIONS

Various methods, systems and apparatus relating to the present invention are disclosed in the following co-pending applications filed by the applicant or assignee of the present invention simultaneously with the present application:

| | | | | | |
|---|---|---|---|---|---|
| AP39 | AP43 | AP44 | AP46 | AP47 | AP48 |
| AP49 | AP50 | AP51 | AP52 | AP53 | AP55 |
| AP58 | AP60 | AP61 | AP62 | AP63 | AP64 |
| AP65 | AP66 | AP67 | AP68 | AP69 | AP70 |
| AP71 | AP77 | AP78 | AP79 | | |

The disclosures of these co-pending applications are incorporated herein by cross-reference. Each application is temporarily identified by its file reference. This will be replaced by the corresponding PCT Application Number when available.

### RELATED PATENT APPLICATIONS AND PATENTS

| | | | |
|---|---|---|---|
| US6,227,652 | US6,213,588 | US6,213,589 | US6,231,163 |
| US6,247,795 | US6,394,581 | US6,244,691 | US6,257,704 |
| US6,416,168 | US6,220,694 | US6,257,705 | US6,247,794 |
| US6,234,610 | US6,247,793 | US6,264,306 | US6,241,342 |
| US6,247,792 | US6,264,307 | US6,254,220 | US6,234,611 |
| US6,302,528 | US6,283,582 | US6,239,821 | US6,338,547 |
| US6,247,796 | US09/113,122 | US6,390,603 | US6,362,843 |
| US6,293,653 | US6,312,107 | US6,227,653 | US6,234,609 |
| US6,238,040 | US6,188,415 | US6,227,654 | US6,209,989 |
| US6,247,791 | US6,336,710 | US6,217,153 | US6,416,167 |
| US6,243,113 | US6,283,581 | US6,247,790 | US6,260,953 |
| US6,267,469 | US6,273,544 | US6,309,048 | US6,420,196 |
| US6,443,558 | US09/422,892 | US6,378,989 | US09/425,420 |
| US09/422,893 | US09/609,140 | US6,409,323 | US6,281,912 |
| US09/575,113 | US6,318,920 | US6,488,422 | US09/693,644 |
| US6,457,810 | US6,485,135 | US09/112,763 | US6,331,946 |
| US6,246,970 | US6,442,525 | US09/505,951 | US09/505,147 |
| US09/505,952 | US09/575,108 | US09/575,109 | US09/575,110 |
| US09/607,985 | US6,398,332 | US6,394,573 | US09/606,999 |
| US6,238,044 | US6,425,661 | US6,390,605 | US6,322,195 |
| US09/504,221 | US6,480,089 | US6,460,778 | US6,305,788 |
| US6,426,014 | US6,364,453 | US6,457,795 | US09/556,219 |
| US09/556,218 | US6,315,399 | US6,338,548 | US09/575,190 |
| US6,328,431 | US6,328,425 | US09/575,127 | US6,383,833 |
| US6,464,332 | US6,390,591 | US09/575,152 | US6,328,417 |
| US6,322,194 | US09/575,177 | US09/575,175 | US6,417,757 |
| US09/608,780 | US6,428,139 | US09/607,498 | US09/693,079 |
| US09/693,135 | US6,428,142 | US09/692,813 | US09/693,319 |
| US09/693,311 | US6,439,908 | US09/693,735 | PCT/AU98/00550 |
| PCT/AU00/00516 | PCT/AU00/00517 | PCT/AU00/00511 | PCT/AU00/00754 |
| PCT/AU00/00755 | PCT/AU00/00756 | PCT/AU00/00757 | PCT/AU00/00095 |
| PCT/AU00/00172 | PCT/AU00/00338 | PCT/AU00/00339 | PCT/AU00/00340 |
| PCT/AU00/00341 | PCT/AU00/00581 | PCT/AU00/00580 | PCT/AU00/00582 |
| PCT/AU00/00587 | PCT/AU00/00588 | PCT/AU00/00589 | PCT/AU00/00583 |
| PCT/AU00/00593 | PCT/AU00/00590 | PCT/AU00/00591 | PCT/AU00/00592 |
| PCT/AU00/00584 | PCT/AU00/00585 | PCT/AU00/00586 | PCT/AU00/00749 |
| PCT/AU00/00750 | PCT/AU00/00751 | PCT/AU00/00752 | PCT/AU01/01332 |
| PCT/AU01/01318 | PCT/AU00/01513 | PCT/AU00/01514 | PCT/AU00/01515 |
| PCT/AU00/01516 | PCT/AU00/01517 | PCT/AU00/01512 | PCT/AU01/00502 |
| PCT/AU02/01120 | PCT/AU00/00333 | PCT/AU01/00141 | PCT/AU01/00139 |
| PCT/AU01/00140 | PCT/AU00/00753 | PCT/AU01/01321 | PCT/AU01/01322 |
| PCT/AU01/01323 | PCT/AU00/00594 | PCT/AU00/00595 | PCT/AU00/00596 |
| PCT/AU00/00597 | PCT/AU00/00598 | PCT/AU00/00741 | PCT/AU00/00742 |

### FIELD OF INVENTION

This invention relates to an onboard information retrieval system and to a method of retrieving information from within a vehicle.

### BACKGROUND TO THE INVENTION

Certain current in-car entertainment systems provide a facility for wireless internet access. Accordingly, they include a web browser and an associated user terminal. This gives occupants of a vehicle equipped with such an in-car entertainment system, the ability to make use of the information available on the internet as an entertainment or educational research facility during appropriate times while in the vehicle.

### SUMMARY OF THE INVENTION

According to a first aspect of the invention, there is provided an onboard information retrieval system, the system including:

a user terminal operable by a user to access a source of the information;

an onboard communications unit for downloading data from the source of the information;

a processing means, in communication with said user terminal, for processing said data to provide formatted data suitable for printing; and

an onboard printing unit associated with said user terminal for printing said formatted data to provide said information.

In this specification, unless the context clearly indicates otherwise, the term “onboard” is to be understood in a broad sense as including a device and its components, which are mounted in a conveyance. Also, in this specification, unless the context clearly indicates otherwise, the term “conveyance” is to be understood in a broad sense as any suitable device for conveying persons and/or goods and includes road vehicles, aircraft, rail vehicles, waterborne craft, spacecraft, or the like.

The user terminal may include a user interface to enable the user to select the information to be printed. Further, the user terminal may include a display means for displaying the information.

The communications unit may be a wireless communications unit The processing means may include a layout engine in communication with the user terminal. The layout engine may cause a description of a page of information to be produced according to content and specific requirements specified by a supplier of the information.

The processing means may further comprise a data manipulating means in communication with the layout engine for manipulating the data to provide the formatted data.

The printing unit may include a printer controller, for receiving the formatted data to be printed, and a printer. The printer may be a full color printer. Preferably, the printer is a photo quality color printer.

Further, the printer may be an ink jet printer. Thus, the printer may comprise a pagewidth ink jet printhead. The printhead may comprise an array of nozzles, said array being fabricated by microelectromechanical techniques.

According to a second aspect of the invention, there is provided a method of retrieving information from within a conveyance, the method including the steps of:

accessing a source of the information;

downloading data from the source of the information via a communications unit arranged in the conveyance;

processing said data to provide formatted data suitable for printing; and

printing, via an onboard printer, said formatted data to provide said information.

The method may include selecting the information to be printed via a user interface of a user terminal. Thus, the method may include displaying the information on a display means prior to printing the information.

The method may include downloading the data to the conveyance via a wireless communications unit.

Further, the method may include causing a description of a page of information to be produced according to content and specific requirements specified by a supplier of the information.

In addition, the method may include manipulating said page of information into a format to suitable to be printed by a printer of the user terminal.

According to a third aspect of the invention, there is provided an onboard information retrieval system, the system including:

a user terminal operable by a user to access a source of the information, the user terminal comprising a user interface and a display means;

an onboard wireless communications unit for downloading data from the source of the information;

a layout engine responsive to the user terminal for processing data at least into textual data;

a pre-printing processing means which is connected to the layout engine and which processes the data from the layout engine to provide formatted data which is in a format which is suitable for printing; and

an onboard printer for printing the formatted data, on demand, to provide a hard copy of the information.

The information may be from the internet and the source of the information may then be accessed through a service provider.

The information may relate to an establishment in the vicinity of the vehicle.

According to a fourth aspect of the invention, there is provided a method of retrieving information from within a vehicle, the method including the steps of:

accessing a source of the information;

downloading data from the source of the information via a communications unit arranged in the vehicle;

processing data at least into textual data by means of a layout engine;

further processing the data from the layout engine to provide formatted data which is in a format which is suitable for printing; and

printing, via an onboard printer, the formatted data, on demand, to provide at least one hard copy of the information.

The information may be from the internet and the method may include accessing the source of the information through a service provider.

The method may include accessing information relating to an establishment in the vicinity of the vehicle.

### BRIEF DESCRIPTION OF THE DRAWINGS

A preferred embodiment of the invention will now be described, by way of example only, with reference to the accompanying drawings, in which:

FIG. 1 shows a block diagram of an onboard information retrieval system, in accordance with the invention;

FIG. 2 shows a three dimensional view of a printer for use with the system;

FIG. 3 shows a three dimensional view of the printer with a cover removed;

FIG. 4 shows a three dimensional, exploded view of the printer;

FIG. 5 shows a sectional side view of the printer;

FIG. 6 shows a three dimensional view of a cartridge for the printer;

FIG. 7 shows a three dimensional, exploded view of the cartridge;

FIG. 8 shows a three dimensional, schematic view of a nozzle assembly for an ink jet printhead for the printer;

FIGS. 9 to 11 show a three dimensional, schematic illustration of an operation of the nozzle assembly of FIG. 8;

FIG. 12 shows a three dimensional view of a nozzle array constituting the printhead;

FIG. 13 shows, on an enlarged scale, part of the array of FIG. 12;

FIG. 14 shows a three dimensional view of the printhead including a nozzle guard;

FIG. 15 shows a schematic diagram of a wireless communications sub-system forming part of the system of FIG. 1; and

FIG. 16 shows a three dimensional view of an implementation of the system.

### DETAILED DESCRIPTION OF PREFERRED EMBODIMENT

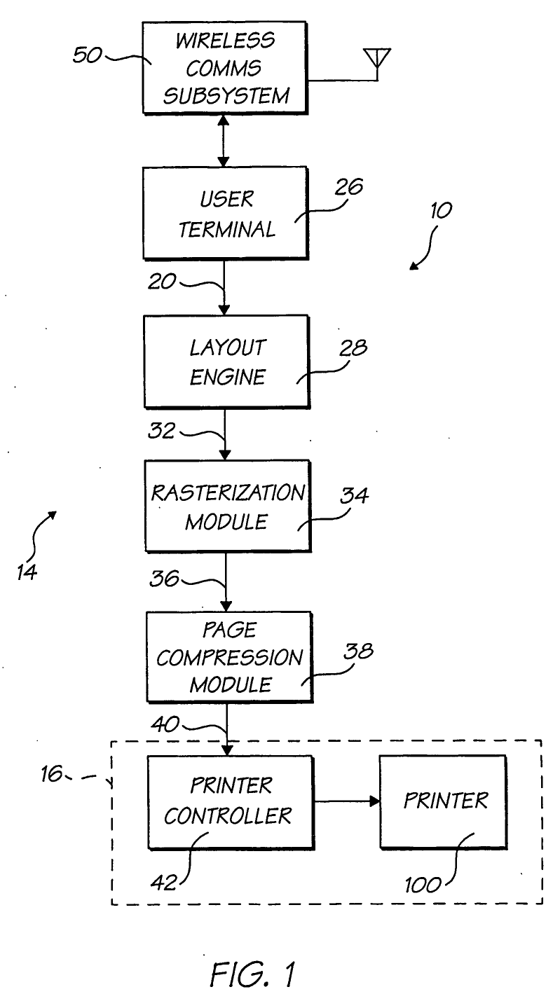

Referring initially to FIG. 1 of the drawings, reference numeral 10 generally designates an onboard (as defined) information retrieval system, in accordance with the invention. The information retrieval system 10 includes a user terminal 26 for accessing the internet in a wireless manner. The user terminal 26 accordingly includes a web browser and an associated user interface.

To enable access to be gained to the internet, a wireless communications sub-system 50 is mounted in the vehicle and communicates with the user terminal 26.

Further, the system 10 includes a processing means 14 that communicates with the user terminal 26 along a data line 20 for receiving data from the user terminal 26.

The data processing means 14 comprises a layout engine 28. The layout engine 28 causes a description of each page to be produced according to content and specific layout requirements specified by an originating server.

The page description output from the layout engine is supplied along a data line 32 to a rasterization module 34 of the processing means 14. The rasterization module 34 communicates with a page compression module 38 via a data line 36. The modules 34 and 38 convert page description data output from the layout engine 28 into formatted data suitable for printing.

The system 10 includes a printer 100 forming part of a printing unit 16. The printing unit 16 includes a printer controller 42 that controls the printer. The printer controller 42 receives the formatted data from the page compression module 38 along a data line 40.

Certain of the components of the system 10 are now described in greater detail.

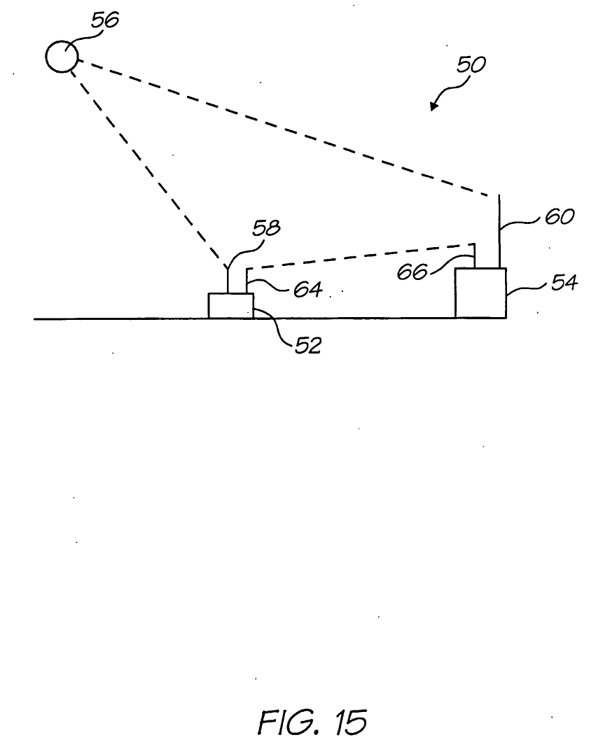

Referring to FIG. 15 of the drawings, various forms of wireless communications sub-system 50 could be employed. One technique is to use a combination of satellite communications and a mobile telephone network.

The sub-system 50 includes a mobile station 52 (being the motor vehicle in this invention) and a fixed station 54. A satellite is designated generally by the reference numeral 56. The satellite 56 communications with the mobile station 52 via a satellite receiver 58. The satellite 56 also communications with the base station 54 via a satellite up link 60.

In addition, the mobile station 52 includes a mobile phone network based transmitter 64, which communicates with a mobile phone network based receiver 66 at the bay station 54.

To enable data to be transmitted from the mobile station 52 to the base station 54, satellite transmission via the satellite 56 is employed as well as the mobile telephone network using the transmitter 64 and the receiver 66.

The layout engine 28 may be required to manipulate data sourced from a plurality of sources. This data may have no embedded layout information. Depending on the kind of content supplied, it may be necessary to firstly create a formatted description of the content, which can then be used to generate one or more pages of page description language.

The page description language to be generated by the layout engine 28 determines the kinds of data elements, and the structuring of elements that may be used to compose a page. For example, if the page description language used is postscript, then the elements that are used to describe the page include filled and stroked paths consisting of line segments and curves, text with corresponding font definitions, and images.

A template for laying out data may be dynamically generated by the layout engine 28 based on user choices, may be a static built-in template, or may even be obtained from some other source such as the source suppling the data.

A number of possibilities exist for layout and content descriptions that can be used to generate a set of consistent layouts for a page containing a number of elements, which may be both textual and graphical.

One example of a method of data layout that allows data to be sourced from a plurality of separate locations is through using a combination of XML (eXtensible Markup Language) and XSL (extensible Stylesheet Language).

XML allows content to be marked up by applying a set of tags to the content. The definition of each tag in particular XML content is described in a separate scheme referenced by the XML.

XSL provides a method of transforming XML into another format (for example HTML) whilst simultaneously performing selection and filtering operations.

The combination of XML content and XSL as a layout specification allows for descriptions of one or more pages to be produced in a formatting language. The formatting language may then be translated into a page description language suitable for printing (i.e., one that provides descriptions of objects, their locations and compositing details).

Another possible layout and content description which can be used is a document which is specified in HTML (Hyper Text Markup Language) which is supplied to the layout engine 28 for the purposes of creating a page description. One or more stylesheets specified according to CSS (Cascading Style Sheet) standard may also be supplied, allowing the layout engine 28 to associate a supplied style with a set of tags. If no style sheet is supplied a set of default styles internal to the layout engine 28 is adopted.

The HTML document is then translated into a page description language suitable for printing.

The rasterization module 34 is provided to convert from page description language into a format that can be sent to the print engine (not shown) of the printer 100. This format may take a number of forms depending on the characteristics of the print engine such as the color gamut of the output device, the types of markers to be used, the number of markers being used (and their respective colors) and the medium being marked.

The page description received by the rasterization module 34 may also take a number of forms. Many page description languages are program oriented in that a page is described in a pragmatically generated manner. Other page description languages describe pages in terms of a set of objects placed on a page by way of a painter's algorithms. Still other page description languages describe a page in terms of a compositing model that defines a hierarchy of objects located on a page, each with a defined compositing order relative to a neighbourhood of other objects.

A number of ways exist in which rasterization of a page, a set of pages, a sub-set of objects on a page or a sub set of objects on a number of pages may be processed by the rasterization module 34.

One method of rasterization involves a divide-and-conquer approach in which the page description language is initially interpreted to form a model of the page. The page is scanned and objects are rasterized as they are encountered and then composited to form pixmap output for a portion of the page. The pixmap is then mapped into the color space of the output device or dithered (or error defused) to match the characteristics required by the output device.

Another method of rasterization which may be employed by the rasterization module 34 is to render each object in full or partially according to the type of object the coverage of the object with respect to the page (and the portion of the page currently being rendered) and caching aspects of the object. For instance, if a character string is to be rasterized, each character in the string may be rasterized in full and then cached for later reuse whereas a filled rectangle may only be rasterized as necessary.

Depending on the output requirements for the rasterization module 34, each page to be rasterized may be generated in its entirety or generated in a band wise fashion for forwarding to the page compression module 38. In this way, if a page is larger than a certain size, and memory needs to be conserved, a page may be divided into a number of bands that may be rasterized on demand.

The page compression module 38 is provided to reduce the amount of rasterized page data that needs to be transferred to the printer controller 42. The page data is compressed using one or more of a number of techniques that do not result in a visible degradation in the quality of the final printed image.

A method of compressing contone data is JPEG compression. With this compression technique, contone pixels are converted into a luminance/chrominance representation which may then efficiently be compressed by using quantization of a discrete cosine transformation of the data. This quantized version of the data is entropy coded to reduce large runs of zero valued elements resulting in an overall 10:1 reduction in data size with virtually no resulting significant loss of image quality.

The wavelet transform, as adopted by the JPEG 2000 standard, is a method used to compress contone data. Two different wavelet transforms are specified by JPEG 2000, namely, a 9/7 wavelet transform for lossy compression and a 5/3 3 wavelet transform for lossless compression. Given that the results of compression using the 9/7 wavelet transform are visually superior to the results of compression using the discrete cosine transform, it is reasonable to expect that a compression ratio of at least 50:1 can be achieved without significant degradation of the reconstructed image.

The scan order adopted by JPEG 2000 is a spiral scan of the original image, traversed one pixel at a time. This is not convenient for printing applications since it would require that the complete page be decoded and stored or that the page be decoded multiple times for printing to be carried out. To remedy this, it may be possible to adopt an alternative scan order that traverses each image row in sequence such that each portion of the image received can be immediately decoded and printed independently of the receipt of the complete compressed page.

Compression of bilevel images may be performed by using the commonly known Group 3 or Group 4 fax algorithms. These algorithms exploit the two dimensional properties of typical bilevel images to achieve an average 30:1 compression.

The JBIG (Joint Bilevel Image Group) has defined a method for the compression of bilevel images called JBIG2 that is able to yield higher compression ratios than the older Group 3 and Group 4 fax algorithms with a more complex encoder/decoder combination. Essentially JBIG2 relies on the encoder to successfully segment an input image into a number of regions that are compressed with techniques specialised according to the properties of the region being encoded. Regions that contain text elements are encoded using an algorithm that stores encoded versions of bitmaps corresponding to each character. Regions that contain half toned images (particularly for the case when ordered half toning has been used) are encoded by storing a dictionary of half toned patterns and the regions to which they apply. Regions that contain other elements such as line art are encoded into a compressed bitmap representation.

In certain instances, page compression may not be required. In that case, the page compression module 38 functions using null compression wherein the page is not compressed at all and the page compression module 38 functions as a pass through module.

The printer controller 42 is responsible for handling the hardware specific aspects of the printing process. This enables a number of different types of printing mechanisms or printers 100 to be adopted without changing details of the system further up the chain of print modules.

The printer controller 42 receives a rasterized version of each page which is usually compressed using one of the compression techniques described above. The page may be received in its entirety or in a band-wise fashion depending on the size of the page and the functioning of the preceding modules 34 and 38.

In the printer controller 42, the page data are progressively accessed in printer order, decompressed if required and organised into a format suitable for hardware of the printer 100 to enable the hardware of the printer 100 to program its printhead 300. This recognition may include such factors as may be necessary to account for special characteristics of a particular printhead 300 such as up scaling and dithering of the print data and adjustments, if necessary, for the markers and paper being used.

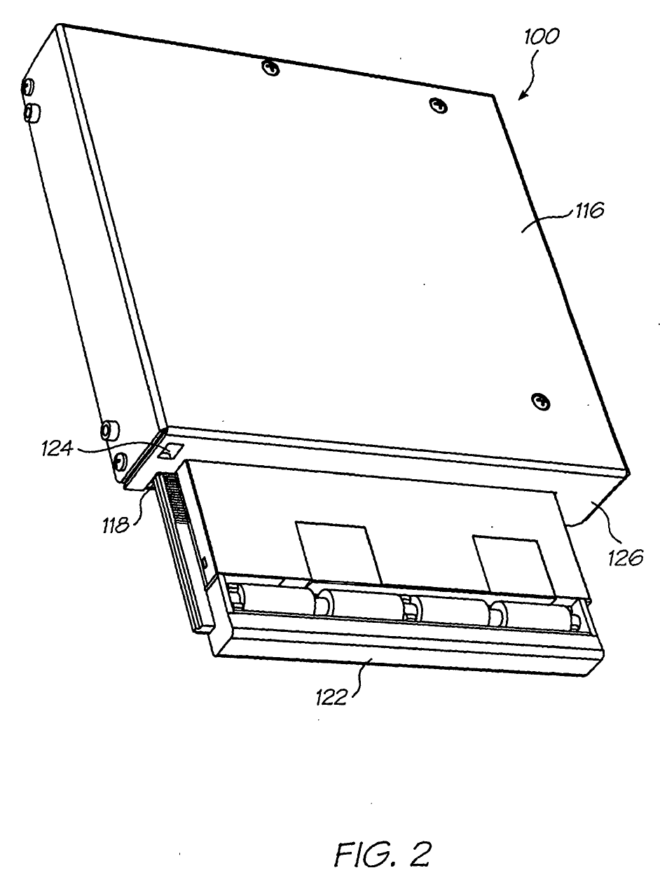

Referring to FIGS. 2 to 7 of the drawings, the printer 100 is described in greater detail.

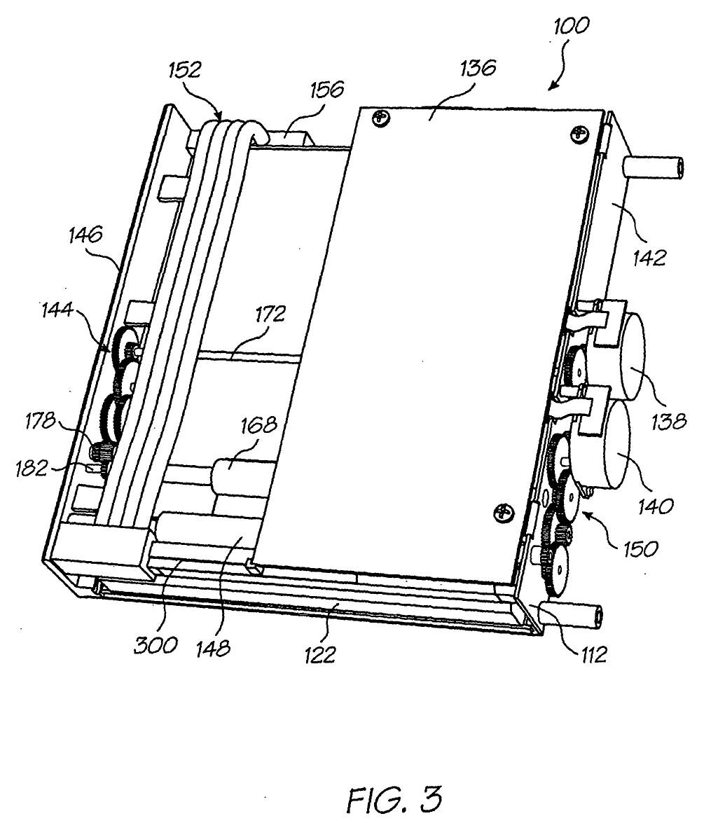

The printer 100 includes a chassis 112 (FIG. 3) which is covered by a top cover 116 that has an access opening 118 closed off by a flap 120. The flap 120 is spring biased so that, when a cartridge 122 has been removed from the printer 100, the flap is urged upwards to close off the access opening 118.

The device which sends commands to the printer 100 can either be hard wired to the printer 100, for example, via a wiring loom of the motor vehicle or, instead, the device may send commands to the printer 100 in a wireless manner. For this purpose, the printer 100 includes a port 124 able to detect wireless communications, such as infra-red communications.

The printer 100 incorporates a printhead 300 (FIG. 3). The printhead 300 is a pagewidth ink jet printhead. More particularly, the printhead 300 is a four color printhead, or three color plus infra red ink printhead, which prints photo quality prints on print media stored in the cartridge 122. The printhead 300 comprises an array of nozzles to provide printing at 1600 dpi. The nozzles of the printhead 300 are manufactured using the applicant's Memjet technology. The printhead is described in greater detail below.

The printhead 300 receives commands from a printed circuit board (PCB) 136 secured to the chassis 112.

A pair of drive motors 138 and 140 is mounted on a sidewall 142 of the chassis 112. The drive motor 138, which is in the form of a stepper motor, drives a first drive arrangement in the form of a first gear train 144. The first gear train 144 is mounted on a side molding 146 of the chassis 112.

The drive motor 140, which is also in the form of a stepper motor, drives a drive roller 148 via a second drive arrangement in the form of a second gear train 150.

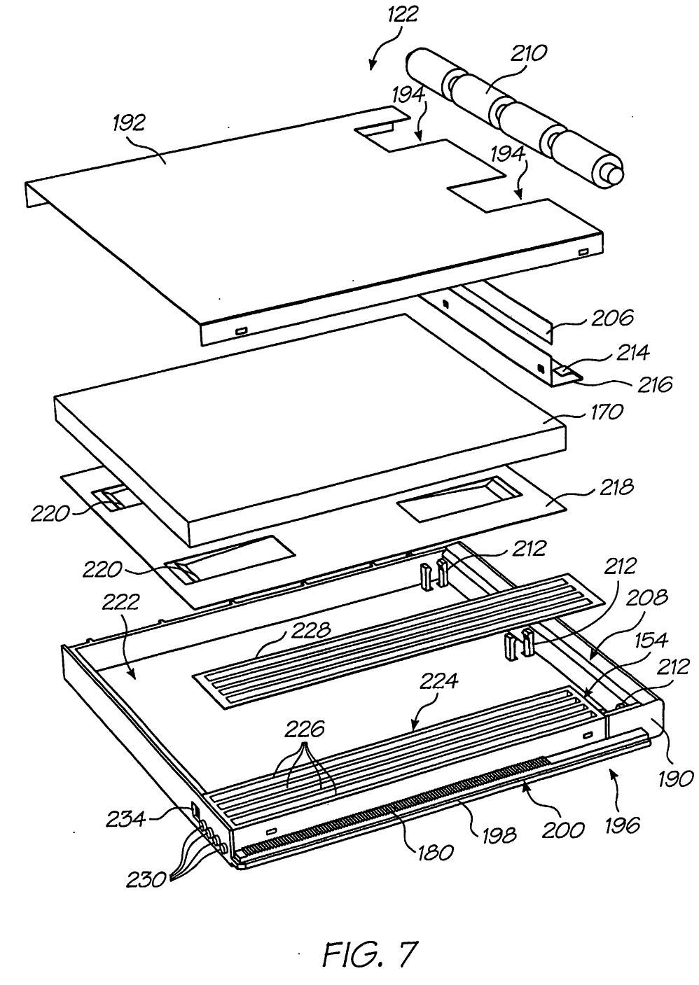

The printhead 300 receives ink from ink hoses 152 which communicate with an ink supply reservoir 154 (FIG. 7) of the cartridge 122 via an ink supply manifold 156, as will be described in greater detail below.

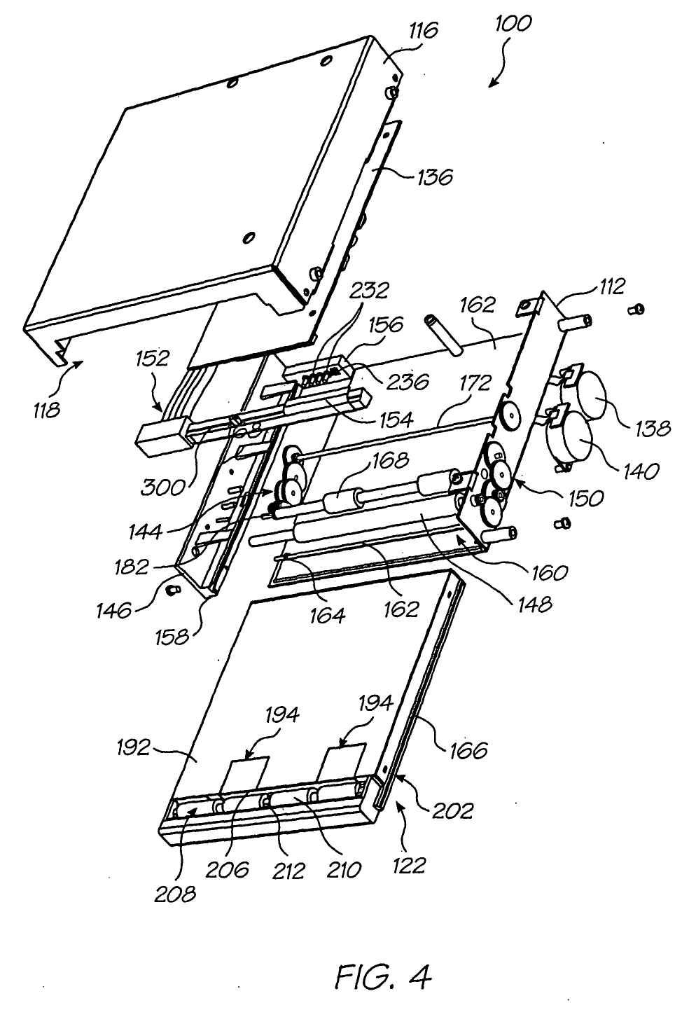

Referring to FIG. 4 of the drawings, an exploded view of the printer 100 is illustrated. It is to be noted that the printhead 300 communicates with the PCB 136 via a TAB film 154.

A slot 158 is defined in the side molding 146. The slot 158 receives a corresponding formation of the cartridge 122 in it. Further, a roller set 160 is mounted on a base 162 of the printer 100. The roller set 160 comprises a rotatable axle 162. A cog 164 is mounted proximate each end of the axle 162. Each cog 164 engages a longitudinally extending rack 200, 202, one on each side of the cartridge 122, for inhibiting skewing of the cartridge 122 as it is inserted into, or withdrawn from, the printer 100.

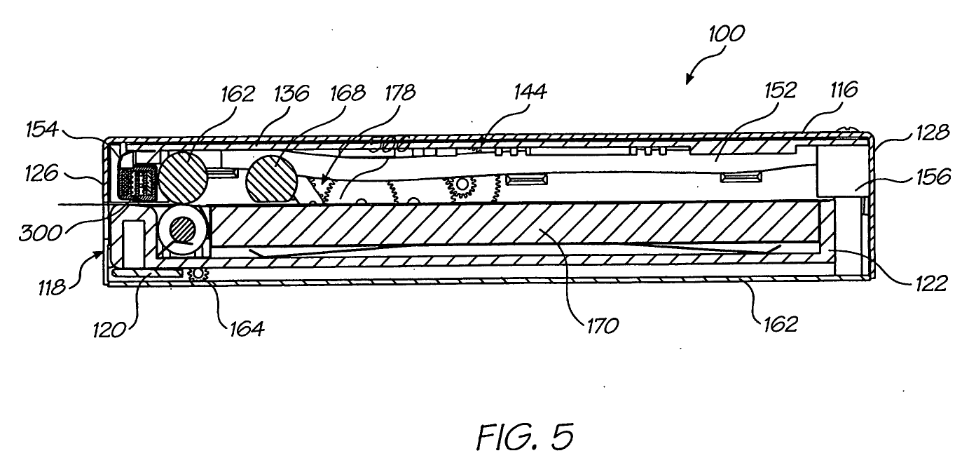

The first gear train 144 engages a pick up roller 168 of the printer 100. The pick up roller 168 picks up print media in the form of a sheet of paper from a stack 170 of paper FIG. 5) in the cartridge 122 for feeding to the printhead 300 of the printer 100 when printing is to be effected.

As shown in greater detail in FIG. 4 of the drawings, the first gear train 144 is powered by the stepper motor 138 via an axle 172 extending across the printer 100 to convey power from the stepper motor 138 to the first gear train 144. A gear 174 is mounted against the molding 146 at one end of the axle 172. The gear 174 drives a reduction gear set 176. Further, the reduction gear set 176 communicates with a reversing mechanism 178. Accordingly, the gear train 144 performs two functions. When the reversing mechanism 178 is not selected, the gear train 144 engages an upper rack 180 on the cartridge 122 for feeding the cartridge 122 into the printer 100 or ejecting the cartridge 122 from the printer 100. Instead, when the reversing mechanism has been selected, it engages the pick up roller 168 or, more particularly, a gear 182 mounted at an end of the pick up roller 168. The gear train 144 then serves to feed the paper to the drive roller 148 for conveying to the printhead 300.

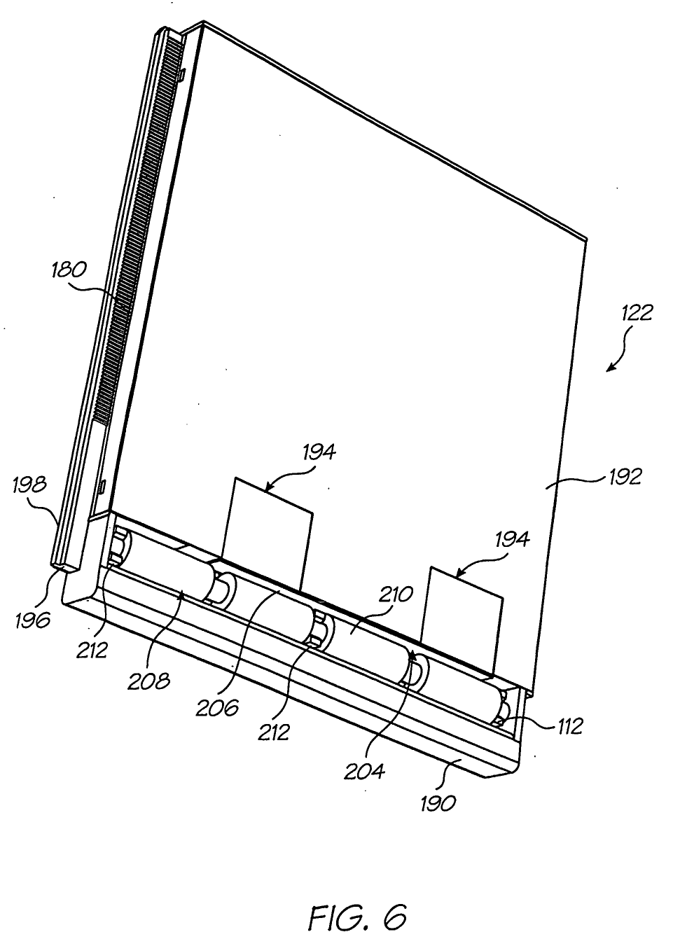

Referring now to FIGS. 6 and 7 of the drawings, the cartridge 122 is described in greater detail.

The cartridge 122 comprises a base molding 190. The base molding 190 is closed off by a metal cover 192. The cover 192 has a pair of transversely spaced openings 194 defined in a front edge thereof These openings 194 permit the pick up roller 168 of the printer 100 to engage a topmost sheet of the stack 170 of paper within the cartridge 122.

A toothed rack 196 is provided on one side of the cartridge 122. The toothed rack 196 defines the upper rack 180 which is engaged by a gear of the first gear train 144 for insertion of the cartridge 122 into, or its ejection from, the printer 100. A rib 198 extends longitudinally along the side of the toothed rack 196. The rib 198 is received in the slot 158 in the side molding 146 of the printer 100. A lower surface of the toothed rack 196 also has one of the longitudinally extending racks 200 FIG. 7) for engagement with one of the cogs 164. An opposed side of the base molding 190 of the cartridge 122 carries the other of the longitudinally extending racks 202 which engages the other cog 164 for inhibiting skewing of the cartridge 122 when it is inserted into, or ejected from, the printer 100.

A feed slot 204 is defined at a front edge of the metal cover through which a sheet of paper to be printed is passed in use. The feed slot 204 is partially defined by a plastics strip 206 which inhibits more than one sheet of paper being fed to the printhead 300 at any one time.

A transversely extending trough 208 is defined outwardly of the strip 206. The trough 208 accommodates a sprung roller 210 therein. The roller 210 is supported in the trough 208 via a plurality of clips 212.

The roller 210 is biased upwardly relative to a base of the trough 208 via a plurality of leaf springs 214. The leaf springs 214 are formed integrally with an L-shaped metal bracket 216 which partially forms the trough 208. The roller 210 is a snap-fit in the clips 212.

A platen 218 is accommodated in the base molding 190. The platen 218 is spring biased via a plurality of leaf springs 220 which engage a floor 222 of the base molding 190 for urging the stack 170 of paper against the cover 192.

The ink supply reservoir 154 includes an ink supply molding 224 formed integrally with the base molding 190. The ink supply molding 224 defines a plurality of ink supply channels 226. Each ink supply channel 226 contains a particular color of ink. In this context, the term “color” is to be understood as including inks which are invisible in the visible spectrum such as, for example, infra red inks.

The channels 226 are closed off by a flexible bladder-like membrane 228 which is heat-sealed to the molding 224. It will be appreciated that, as ink is withdrawn from each channel 226, the associated membrane 228 collapses into the channel 226 thereby inhibiting the ingress of air into that channel 226.

Each channel 226 communicates with an ink outlet 230. Each ink outlet 230 is in the form of a rupturable seal.

As shown in greater detail in FIG. 4 of the drawings, the ink supply manifold 156 of the printer 100 includes pins 232. These pins 232 communicate with the ink supply hoses 152. When the cartridge 122 is inserted into the printer 100, and the cartridge 122 is driven home by the gear train 144, the pins 232 pierce the seals 230 to place the hoses 152 in communication with their associated ink supply channels 226.

The cartridge 122 includes a quality assurance chip 234. This chip 234 ensures correct communications between the cartridge 122 and the printer 100 and that the cartridge 122 is of the required quality. The chip 234 communicates with the printer 100 via chip contacts 236 mounted on the ink supply manifold 156 of the printer 100. Thus, when the cartridge 122 is driven home by the gear train 144, the chip 234 engages the contacts 236 for enabling communications to be established between the chip 234 and the circuit board 136 of the printer 100.

The cartridge 122 is a disposable unit so that, once its ink supply and paper supply have been depleted, the cartridge is disposed of Instead, the cartridge 122 may be re-useable. In the latter case, once the supply of ink and paper in the cartridge 122 have been depleted and the cartridge 122 is ejected from the printer 100, the used, empty cartridge 122 can be taken by a user to a supplier for a refund. It is to be noted that the cartridge 122 is automatically ejected from the printer 100 once its supply of paper and/or ink has been depleted.

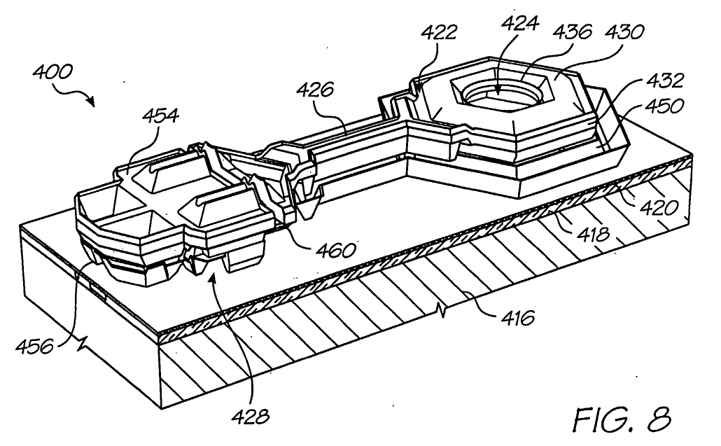

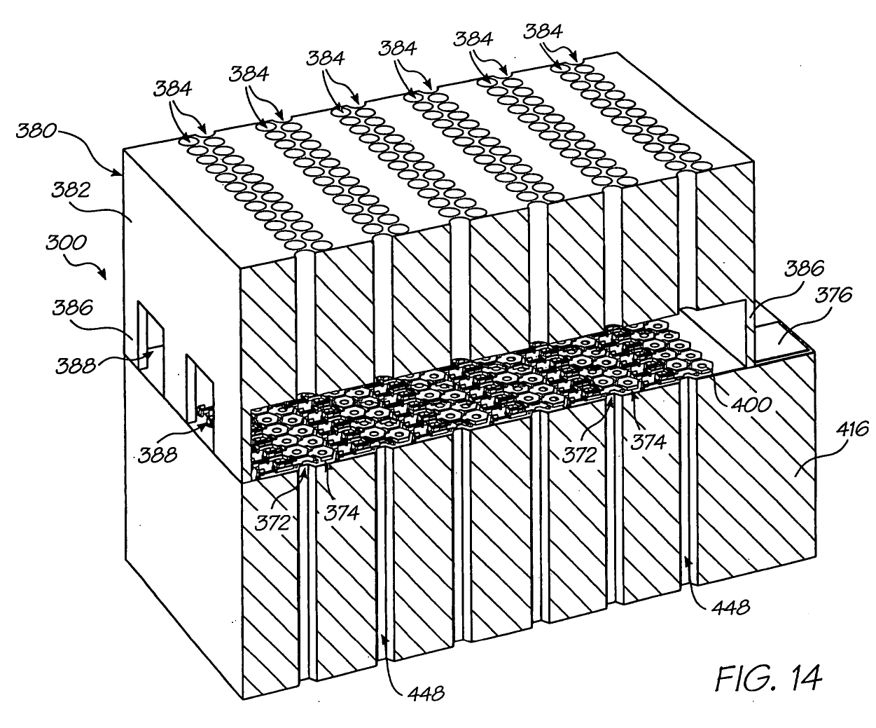

Referring to FIGS. 8 to 14 of the drawings, the printhead 300 is described in greater detail. The printhead 300 comprises an array, which will be described in greater detail below, of nozzle assemblies. In a particularly preferred form, the printhead includes Memjet technology as described in the patent applications and patents listed in the paragraph headed “Related Patent Applications and Patents”, at page 2, the disclosure of which is incorporated herein by way of explicit reference.

Referring initially to FIG. 8 of the drawings, a nozzle assembly is illustrated and is designated generally by the reference numeral 400 The assembly 400 includes a silicon substrate or wafer 416 on which a dielectric layer 418 is deposited. A CMOS passivation layer 420 is deposited on the dielectric layer 418.

Each nozzle assembly 400 includes a nozzle 422 defining a nozzle opening 424, a connecting member in the form of a lever arm 426 and an actuator 428. The lever arm 426 connects the actuator 428 to the nozzle 422.

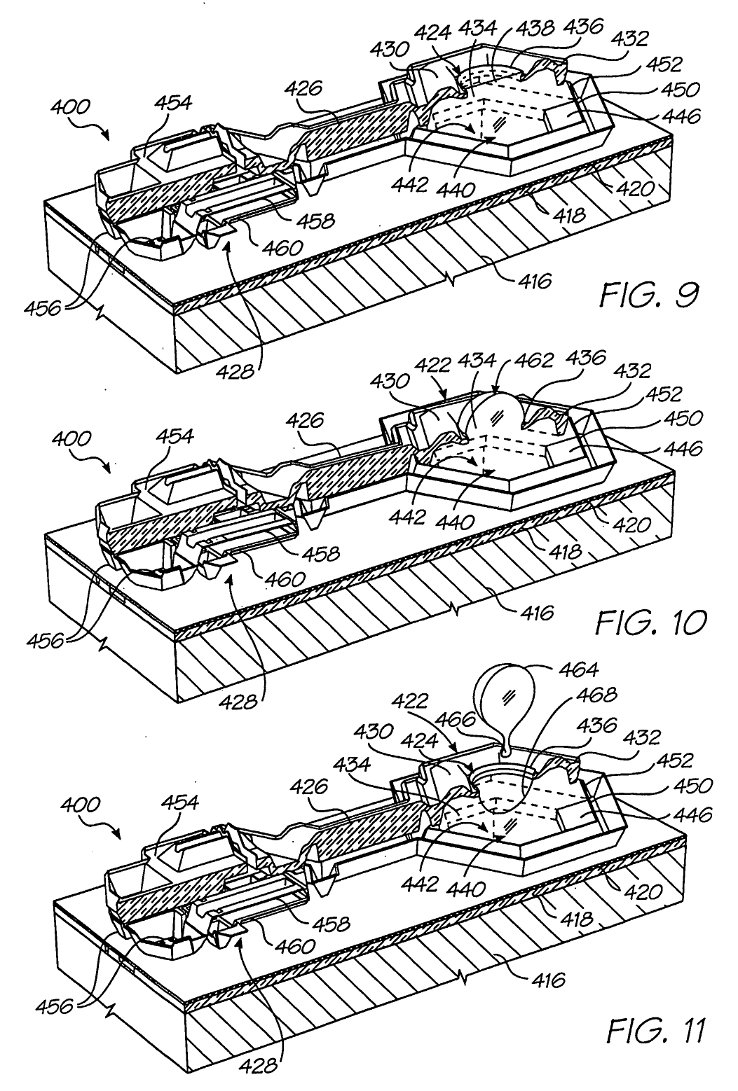

As shown in greater detail in FIGS. 9 to 11 of the drawings, the nozzle 422 comprises a crown portion 430 with a skirt portion 432 depending from the crown portion 430. The skirt portion 432 forms part of a peripheral wall of a nozzle chamber 434. The nozzle opening 424 is in fluid communication with the nozzle chamber 434. It is to be noted that the nozzle opening 424 is surrounded by a raised rim 436 which “pins” a meniscus 438 (FIG. 9) of a body of ink 440 in the nozzle chamber 434.

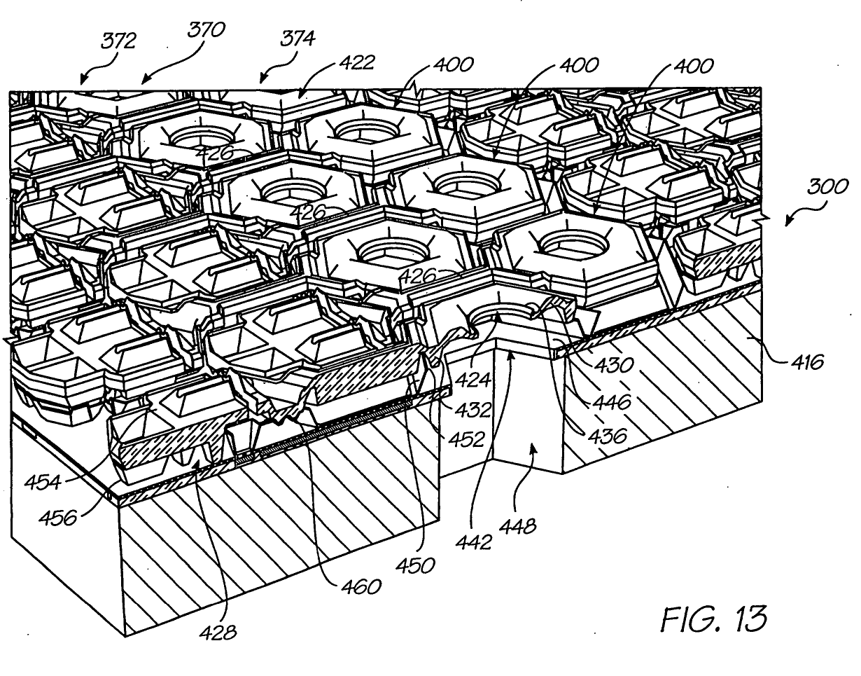

An ink inlet aperture 442 (shown most clearly in FIG. 13 of the drawings) is defined in a floor 446 of the nozzle chamber 434. The aperture 442 is in fluid communication with an ink inlet channel 448 defined through the substrate 416.

A wall portion 450 bounds the aperture 442 and extends upwardly from the floor portion 446. The skirt portion 432, as indicated above, of the nozzle 422 defines a first part of a peripheral wall of the nozzle chamber 434 and the wall portion 450 defines a second part of the peripheral wall of the nozzle chamber 434.

The wall 450 has an inwardly directed lip 452 at its free end which serves as a fluidic seal which inhibits the escape of ink when the nozzle 422 is displaced, as will be described in greater detail below. It will be appreciated that, due to the viscosity of the ink 440 and the small dimensions of the spacing between the lip 452 and the skirt portion 432, the inwardly directed lip 452 and surface tension function as a seal for inhibiting the escape of ink from the nozzle chamber 434.

The actuator 428 is a thermal bend actuator and is connected to an anchor 454 extending upwardly from the substrate 416 or, more particularly, from the CMOS passivation layer 420. The anchor 454 is mounted on conductive pads 456 which form an electrical connection with the actuator 428.

The actuator 428 comprises a pair of first, active beams 458 arranged above a pair of second, passive beams 460. In a preferred embodiment, both pairs of beams 458 and 460 are of, or include, a conductive ceramic material such as titanium nitride (TiN).

Both pairs of beams 458 and 460 have their first ends anchored to the anchor 454 and their opposed ends connected to the arm 426. When a current is caused to flow through the active beams 458 thermal expansion of the beams 458 result. As the passive beams 460, through which there is no current flow, do not expand at the same rate, a bending moment is created causing the arm 426 and, hence, the nozzle 422 to be displaced downwardly towards the substrate 416 as shown in FIG. 10 of the drawings. This causes ejection of ink through the nozzle opening 424 as shown at 462 in FIG. 10 of the drawings. When the source of heat is removed from the active beams 458, i.e. by stopping current flow, the nozzle 422 returns to its quiescent position as shown in FIG. 11 of the drawings. When the nozzle 422 returns to its quiescent position, an ink droplet 464 is formed as a result of the breaking of an ink droplet neck as illustrated at 466 in FIG. 11 of the drawings. The ink droplet 464 then travels on to the print media such as a sheet of paper. As a result of the formation of the ink droplet 464, a “negative” meniscus is formed as shown at 468 in FIG. 11 of the drawings. This “negative” meniscus 468 results in an inflow of ink 440 into the nozzle chamber 434 such that a new meniscus 438 is formed in readiness for the next ink drop ejection from the nozzle assembly 400.

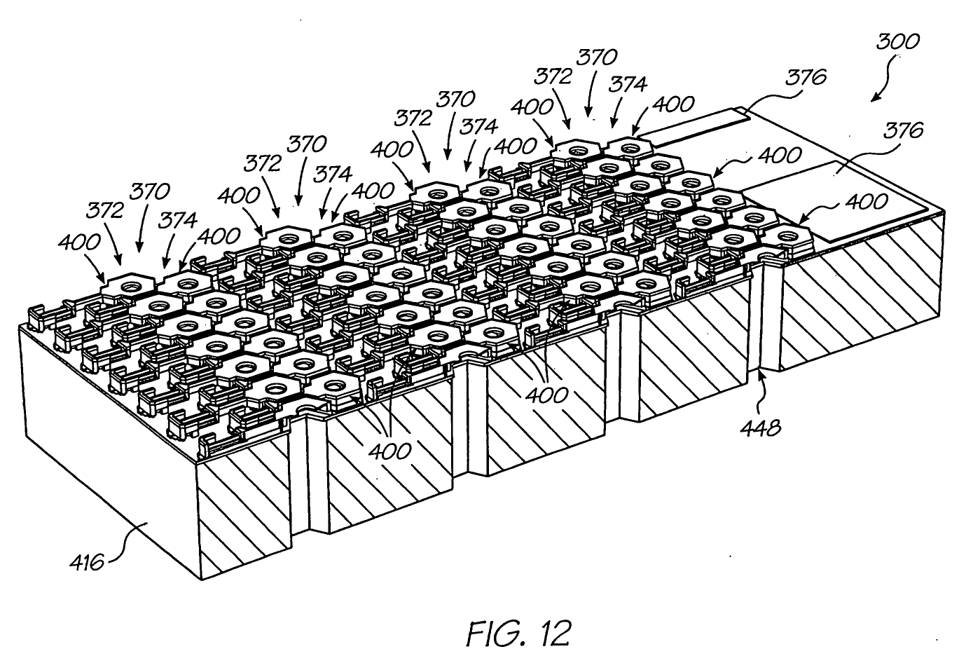

Referring now to FIGS. 12 to 14 of the drawings, a part of the printhead 300 is described in greater detail. The printhead 300 is a four color printhead. Accordingly, the printhead 300 includes four groups 370 of nozzle assemblies, one for each color. Each group 370 has its nozzle assemblies 400 arranged in two rows 372 and 374. One of the groups 370 is shown in greater detail in FIG. 13 of the drawings.

To facilitate close packing of the nozzle assemblies 400 in the rows 372 and 374, the nozzle assemblies 400 in the row 374 are offset or staggered with respect to the nozzle assemblies 400 in the row 372. Also, the nozzle assemblies 400 in the row 372 are spaced apart sufficiently far from each other to enable the lever arms 426 of the nozzle assemblies 400 in the row 374 to pass between adjacent nozzles 422 of the assemblies 400 in the row 372. It is to be noted that each nozzle assembly 400 is substantially dumbbell shaped so that the nozzles 422 in the row 372 nest between the nozzles 422 and the actuators 428 of adjacent nozzle assemblies 400 in the row 374.

Further, to facilitate close packing of the nozzles 422 in the rows 372 and 374, each nozzle 422 is substantially hexagonally shaped.

The substrate 416 has bond pads 376 arranged thereon which provide the electrical connections, via the pads 456, to the actuators 428 of the nozzle assemblies 400. These electrical connections are formed via the CMOS layer (not shown).

A nozzle guard 380 is mounted on the substrate 416 of the printhead 300. The nozzle guard 380 includes a body member 382 having a plurality of passages 384 defined therethrough. The passages 384 are in register with the nozzle openings 424 of the nozzle assemblies 400 of the printhead 300 such that, when ink is ejected from any one of the nozzle openings 424, the ink passes through the associated passage 384 before striking the print media.

The body member 382 is mounted in spaced relationship relative to the nozzle assemblies 400 by limbs or struts 386. One of the struts 836 has air inlet openings 388 defined therein.

When the printhead 300 is in operation, air is charged through the inlet openings 388 to be forced through the passages 384 together with ink travelling through the passages 384. The purpose of the air is to maintain the passages 384 clear of foreign particles. A danger exists that these foreign particles, such as dust particles, could fall onto the nozzle assemblies 400 adversely affecting their operation. With the provision of the air inlet openings 388 in the nozzle guard 380 this problem is, to a large extent, obviated.

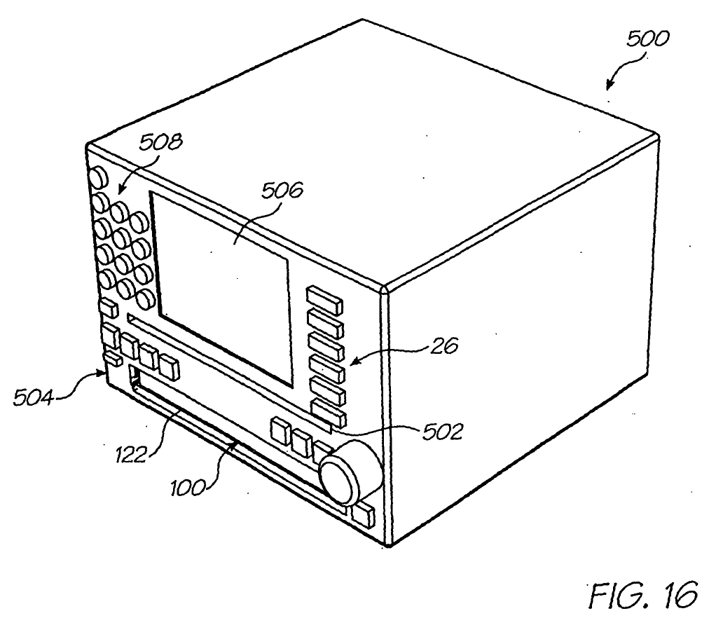

In another embodiment of the invention, the printer 100 is built into and forms part of an in-car entertainment unit 500, as shown in FIG. 16 of the drawings.

The ICE unit 500, in addition to a CD player 502 and a radio having controls 504, includes a full color LCD 506. The unit 500 functions as a satellite navigation unit and may also be used for receiving television or data signals. The unit 500 incorporates a printer 100 of the type described above. The unit 500 includes a bank of control buttons 508. This bank of buttons 508 constitutes GPS controls and is used for satellite navigation purposes. In addition, the unit includes the user terminal 26 which is provided for controlling the printer 100 and the content printed by the printer 100.

In use, when an occupant of the vehicle desires to download information from the internet, the occupant makes use of the user terminal 26. As described above, the user terminal 26 provides interaction and display facilities including rendering of content potentially provided in one of a number of formats (for example, HTML). Interactions with the internet are mainly in the form of events typically encountered during the course of a web browsing activity such as following of hyperlinks, keyboard entry to complete forms, or the like.

When the user wishes to download data and print it on the printer 100, the user terminal 26 forwards the necessary information to the layout engine 28 where the data are formatted into a suitable page description. The page description is output on line 32 to the rasterization module 34 and the page compression module 38 of the processing means 14 to output formatted data for printing on the printer 100.

An example of an application of the system 10 is in on-line, in-vehicle purchasing such as buying an item from an on-line merchant This entails a number of steps to be carried out by the vehicle occupant. Firstly, the occupant browses through one or more on-line catalogues to determine if there is a particular item that the occupant is interested in purchasing. If such an item is located, the occupant enters his or her details, such as name, address and purchase authorisation into the system 10 via the user terminal 26. These details are transmitted via the sub-system 50 to a remote server where they are accessed and processed by the merchant leading to the purchase of the item selected by the occupant. The merchant generates a page of content describing the purchase as a receipt for the occupant of the vehicle. This receipt is transmitted to the system 10 via the wireless communications sub-system 50 and can be printed out on the printer 100. The receipt is kept by the occupant for future reference.

Another application of the system 10 is as part of a reservation or booking system. Examples of this application include making restaurant reservations and on-line purchasing of tickets for events.

If the occupants of the vehicle intended to visit a restaurant for a meal in the vicinity of the vehicle or at their destination, the system 10 could be used to locate and reserve tables at a restaurant of their choosing.

If the occupants of the vehicle are uncertain as to the particular restaurant at which they wish to make a reservation the system 10 could be used to perform a search using an on-line index of restaurants, categorised by location and type of cuisine. Further, restaurant reviews may also be accessed via the system 10 to assist in making a decision as to which restaurant to visit. After a decision regarding the restaurant has been made, the restaurant is contacted via the system 10 using the internet and the reservation is made.

As a development of this aspect, the occupants of the vehicle could, if desired, select their menu items while en route to the restaurant and transmit this information to the restaurant accordingly.

If necessary, a receipt for the reservation may be generated and transmitted to the system 10 from the restaurant via the wireless communications sub-system 50 to be printed out on the printer 100 of the system 10.

It will be appreciated that a similar method could be used for ordering take away food and even making payment in advance via a secure payment system of the internet. Upon arrival at the take away food outlet a receipt, having been printed on the printer 100, is presented to collect the food.

Making use of an on-line ticketing service is also possible with the present system 10. If occupants of the vehicle intended to attend an event at their destination they can make use of the ticketing service to locate an event or, if they are aware of a particular event, to make reservations for the event Once the reservations have been made, tickets for the event are printed on the printer 100 or a receipt to be presented at a ticketing office at a venue of the event may be printed.

It will also be appreciated that general content from the internet may be downloaded and printed, as desired, using the system 10.

Accordingly, it is an advantage of the invention that a system 10 is provided which lends itself to browsing of the web from within a vehicle and to use the potential of the web for making purchases, reservations, or the like. This may be particularly advantageous where the schedule of the occupant of the vehicle is very full and little time is available for conducting transactions of this type.

Although the invention has been described with reference to a number of specific embodiments, it will be appreciated by those skilled in the art that the invention can be embodied in many other forms.

1. An onboard information retrieval system, the system including:
a user terminal operable by a user to access a source of the information;
an onboard communications unit for downloading data from the source of the information;
a processing means, in communication with said user terminal, for processing said data to provide formatted data suitable for printing; and
an onboard printing unit associated with said user terminal for printing said formatted data to provide said information.

2. The system of claim 1 in which the user terminal includes a user interface to enable the user to select the information to be printed.

3. The system of claim 2 in which the user terminal includes a display means for displaying the information.

4. The system of claim 1 in which the communications unit is a wireless communications unit.

5. The system of claim 1 in which the processing means includes a layout engine in communication with the user terminal.

6. The system of claim 5 in which the layout engine causes a description of a page of information to be produced according to content and specific requirements specified by a supplier of the information.

7. The system of claim 6 in which the processing means further comprises a data manipulating means in communication with the layout engine for manipulating the data to provide the formatted data.

8. The system of claim 7 in which the printing unit includes a printer controller, for receiving the formatted data to be printed, and a printer.

9. The system of claim 8 in which the printer is a full color printer.

10. The system of claim 9 in which said printer is a photo quality color printer.

11. The system of claim 9 in which the printer is an inkjet printer.

12. The system of claim 10 in which the printer comprises a pagewidth inkjet printhead.

13. The system of claim 12 in which the printhead comprises an array of nozzles, said array being fabricated by microelectromechanical techniques.

14. A method of retrieving information from within a conveyance, the method including the steps of:
accessing a source of the information;
downloading data from the source of the information via a communications unit arranged in the conveyance;
processing said data to provide formatted data suitable for printing; and
printing, via an onboard printer, said formatted data to provide said information.

15. The method of claim 14 which includes selecting the information to be printed via a user interface of a user terminal.

16. The method of claim 14 which includes displaying the information on a display means prior to printing the information.

17. The method of claim 14 which includes downloading the data via a wireless communications unit.

18. The method of claim 14 which includes causing a description of a page of information to be produced according to content and specific requirements specified by a the information.

19. The method of claim 18 which includes manipulating said page of information into a format to suitable to be printed by a printer of the user terminal.

20. An onboard information retrieval system, the system including:
a user terminal operable by a user to access a source of the information, the user terminal comprising a user interface and a display means;
an onboard wireless communications unit for downloading data from the source of the information;
a layout engine responsive to the user terminal for processing data at least into textual data;
a pre-printing processing means which is connected to the layout engine and which processes the data from the layout engine to provide formatted data which is in a format which is suitable for printing; and
an onboard printer for printing the formatted data, on demand, to provide a hard copy of the information.

21. The system of claim 20 in which the information is from the interact and the source of the information is accessed through a service provider.

22. The system of claim 20 in which the information relates to an establishment in the vicinity of the vehicle.

23. A method of retrieving information from within a vehicle, the method including the steps of:
accessing a source of the information;
downloading data from the source of the information via a communications unit arranged in the vehicle;
processing data at least into textual data by means of a layout engine;
further processing the data from the layout engine to provide formatted data which is in a format which is suitable for printing; and
printing, via an onboard printer, the formatted data, on demand, to provide at least one hard copy of the information.

24. The method of claim 23 in which the information is from the internet and in which the method includes accessing the source of the information through a service provider.

25. The method of claim 23 which includes accessing information relating to an establishment in the vicinity of the vehicle.
